(19) United States
(12) Patent Application Publication
(10) Pub. No.: US 2025/0253101 A1
(43) Pub. Date: Aug. 7, 2025

(54) HYDROGEL ELECTROLYTE AND ELECTROCHEMICAL ENERGY STORAGE DEVICE

(71) Applicant: National Tsing Hua University, Hsinchu City (TW)

(72) Inventors: Yen-Yu Tung, Hsinchu City (TW); Han-Yi Chen, Hsinchu City (TW)

(73) Assignee: National Tsing Hua University, Hsinchu City (TW)

(21) Appl. No.: 18/604,405

(22) Filed: Mar. 13, 2024

(30) Foreign Application Priority Data
Feb. 1, 2024 (TW) 113103900

(51) Int. Cl. H01G 11/60; H01G 11/62; H01M 10/02

(52) U.S. Cl. CPC H01G 11/60; H01G 11/62; H01M 10/02; H01M 2300/0002

(57) ABSTRACT

A hydrogel electrolyte and an electrochemical energy storage device are disclosed. The hydrogel electrolyte includes a hydrogel and electrolyzed salts. The hydrogel is a product from the reaction of a mixture of polyvinyl alcohol (PVA) and polyethylene oxide (PEO) with a borax aqueous solution. The electrolyzed salts are distributed within the hydrogel and dissociated into a cation and an anion. The electrochemical energy storage device includes the above hydrogel electrolyte.

### CROSS-REFERENCE TO RELATED APPLICATION

This application claims the priority benefit of Taiwan application serial no. 113103900, filed on Feb. 1, 2024. The entirety of the above-mentioned patent application is hereby incorporated by reference herein and made a part of this specification.

### BACKGROUND

### Technical Field

The disclosure relates to a hydrogel technology, and particularly relates to a hydrogel electrolyte and an electrochemical energy storage device.

### Description of Related Art

In recent years, along with gradual popularity of wearable electronic devices, functional demands for energy storage devices are also increasing. Currently, many research efforts are made to develop electrochemical energy storage devices with tensile and self-healable properties, such as lithium-ion batteries, zinc ion batteries, supercapacitors, etc.

For example, supercapacitors have an advantage of high power density, which allows fast charging and discharging, while electrolytes therein mainly play a role of ion transfer and neutralizing electrode charges.

However, in order to design functional devices, electrolytes of the supercapacitor are usually in the form of polymers to achieve relevant functions, which affects ionic conductivity of the electrolytes. Therefore, how to simultaneously improve mechanical properties and ionic conductivity of the electrolytes will be an urgent problem that needs to be solved.

### SUMMARY

The disclosure is directed to a hydrogel electrolyte, which meets requirements of ionic conductivity and mechanical properties, and has self-healable ability.

The disclosure is further directed to an electrochemical energy storage device including the above hydrogel electrolyte.

The disclosure provides a hydrogel electrolyte including a hydrogel and electrolyzed salts. The hydrogel is a product from a reaction of a mixture of polyvinyl alcohol (PVA) and polyethylene oxide (PEO) with a borax aqueous solution. The electrolyzed salts are distributed within the hydrogel and dissociated into a cation and an anion.

In an embodiment of the disclosure, a weight ratio of the polyvinyl alcohol to the polyethylene oxide in the mixture is 5:1 to 15:1.

In an embodiment of the disclosure, taking a total volume of the above mixture as 100 vol %, a content of the borax aqueous solution is 0.5 vol. % to 5 vol. %.

In an embodiment of the disclosure, a volume molar concentration of the borax aqueous solution is between 20 mM and 100 mM.

In an embodiment of the disclosure, taking a total weight of the hydrogel as a reference, a content of the electrolyzed salts is 15 wt % to 30 wt %.

In an embodiment of the disclosure, the electrolyzed salts are lithium salts, sodium salts, or zinc salts.

The disclosure provides an electrochemical energy storage device including the above hydrogel electrolyte.

In another embodiment of the disclosure, the electrochemical energy storage device is a supercapacitor.

In another embodiment of the disclosure, the electrochemical energy storage device is an aqueous metal ion battery.

Based on the above description, the disclosure improves the ionic conductivity of the hydrogel through materials of a specific composition, and adds borax aqueous solution to improve the self-healable ability of the hydrogel, so that the hydrogel electrolyte with both ionic conductivity and mechanical properties may be fabricated. Such hydrogel electrolyte is suitable for various electrochemical energy storage devices, such as supercapacitors or aqueous metal ion batteries.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of an electrochemical energy storage device according to an embodiment of the disclosure.

FIG. 2 is a Fourier-transform infrared spectroscopy (FTIR) analysis chart of a hydrogel electrolyte of an experimental example 1.

FIG. 3 is a Raman analysis chart of the hydrogel electrolyte of the experimental example 1.

FIG. 4A is an electrochemical impedance spectroscopy (EIS) test curve chart of the hydrogel electrolyte in the experimental example 1.

FIG. 4B is an EIS test curve chart of a hydrogel electrolyte of an experimental example 2.

FIG. 5A is an EIS test curve chart related to self-healing in the experimental example 1.

FIG. 5B is an EIS test curve chart related to self-healing in the experimental example 1.

FIG. 6 is a galvanostatic charge/discharge cycle (GCD) curve chart of an experimental example 3.

FIG. 7 is a cycle curve chart of the experimental example 3.

FIG. 8 is a GCD curve chart related to stretching in the experimental example 3.

FIG. 9 is a GCD curve chart related to self-healing in the experimental example 3.

FIG. 10 is a cyclic voltammetry (CV) curve chart of an experimental example 4.

FIG. 11 is a GCD curve chart of the experimental example 4.

### DESCRIPTION OF THE EMBODIMENTS

The following content provides many different embodiments for implementing different features of the disclosure. However, these embodiments are only examples and are not intended to limit the scope and application of the disclosure.

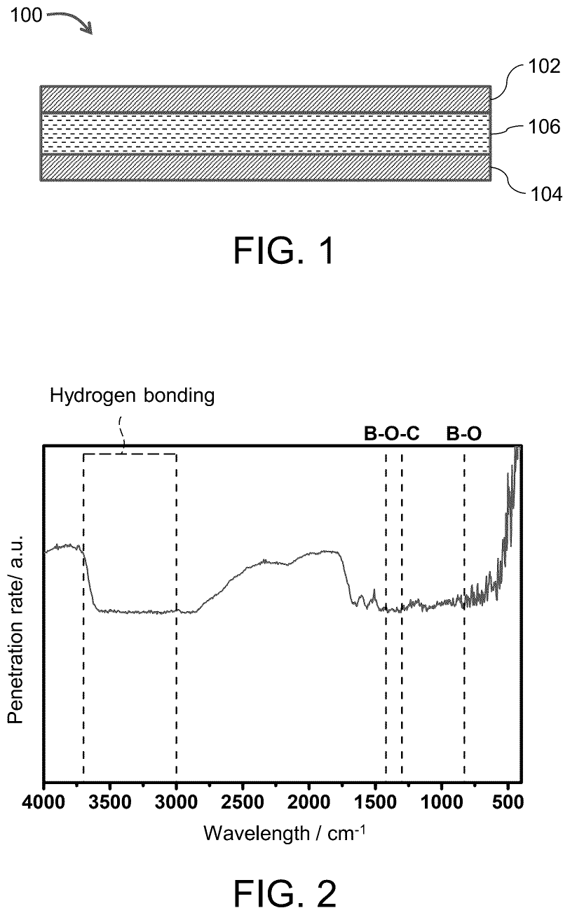

FIG. 1 is a schematic diagram of an electrochemical energy storage device according to an embodiment of the disclosure.

Referring to FIG. 1, an electrochemical energy storage device 100 of the embodiment contains a hydrogel electrolyte 106. The hydrogel electrolyte 106 includes a hydrogel and electrolyzed salts. The hydrogel is a product from reaction of a mixture of polyvinyl alcohol (PVA) and polyethylene oxide (PEO) with a borax aqueous solution, where a chemical formula of borax is Na₂B₄O₇·10H₂O. The PVA is a main component in the hydrogel, and the PEO has an effect of improving tensile properties, and the borax aqueous solution may form self-healable bonds, which improve the self-healable properties of the hydrogel. In an embodiment, a weight ratio of the PVA to the PEO in the above mixture may be between 5:1 and 15:1, such as 6:1, 7:1, 8:1, 9:1, 10:1, 11:1, 12:1, 13:1, 14:1, etc. If a total volume of the mixture is 100 vol %, the content of the borax aqueous solution may be between 0.5 vol. % and 5 vol. %, such as 1 vol. %, 2 vol. %, 3 vol. %, 4 vol. % etc. If the content of the borax aqueous solution is above 0.5 vol. %, it is expected that sufficient self-healable bonds will be produced; if the content of the borax aqueous solution is below 5 vol. %, there will be less water discharge problems. In an embodiment, a volume molar concentration of the borax aqueous solution may be between 20 mM and 100 mM, such as 30 mM, 40 mM, 50 mM, 60 mM, 70 mM, 80 mM, 90 mM, etc.

The electrolyzed salts in the hydrogel electrolyte 106 are distributed within the hydrogel and may be dissociated into a cation and an anion. In an embodiment, a total weight of the hydrogel is taken as a reference, the content of the electrolyzed salts is 15 wt % to 30 wt %. The electrolytic salts may be lithium salts (such as LiCl), sodium salts (such as NaCl) or zinc salts (such as Zn(CF₃SO₃)₂).

Referring to FIG. 1, in the embodiment, the electrochemical energy storage device 100 may be a supercapacitor. The electrochemical energy storage device 100 may basically consist of a first electrode 102, a second electrode 104 and the hydrogel electrolyte 106 disposed there between, but the electrochemical energy storage device 100 may be added with other components (not shown), and is limited to what is shown in the figure.

In another embodiment, the electrochemical energy storage device 100 may be an aqueous metal ion battery, and the electrochemical energy storage device 100 may basically consist of the first electrode (positive electrode) 102, the second electrode (negative electrode) 104 and the hydrogel electrolyte 106 disposed there between, but the electrochemical energy storage device 100 may be added with other components (not shown), and is limited to what is shown in the figure. The aqueous metal ion battery may include, but is not limited to, lithium ion battery, zinc ion battery, etc.

Following experiments are listed to verify implementation effects of the disclosure, but the disclosure is not limited to the following content.

### [Raw Materials]

1. PVA powder: ACROS Organics, ECH-ACR-183121000.
2. PEO powder: Aldrich, 182028.
3. Borax: Kanto chemical, CAJO-37127-00.
4. Lithium salt LiCl: Alfa Aesar, 14540.
5. Zinc salt Zn(CF₃SO₃)₂: Alfa Aesar, L15969.
6. Acidified multi-walled carbon nanotubes (MWCNT-COOH): CONJUTEK, L-MWCNT1020-COOH.
7. Single-walled carbon nanotube (SWCNT): Carbon Solution, sku-P3-SWNT.
8. Manganese sulfate hydrate (MnSO₄·H₂O): ACROS Organics, 205905000.
9. Vanadium pentoxide (V₂O₅): SHOWA, 2201-5150-000-23SW.
10. Anhydrous ethanol: ECHO CHEMICAL, ETA95-ENTR-AA-75EC.
11. Zinc powder: Alfa Aesar, 10440.

### Experimental Example 1

First, after adding 0.4 g of the PVA powder and 0.04 g of the PEO powder to 10 mL of water, the mixture is placed on a heating plate and stirred for 10 minutes at room temperature, and then the heating plate is adjusted to 90° C. and the mixture is kept being stirred for about an hour until the powders are completely dissolved.

Then, 0.2 mL of 50 mM borax solution is added and stirred for 10 minutes, and then transferred to a culture dish for Freeze-Thawing (first freeze in a −18° C. refrigerator for one hour, and then place the solution at room temperature for one hour, and repeat the previous steps of freezing to room temperature by three times), and then the solidified solution is placed in a −60° C. freeze dryer to dry for one day, and then cut into a size of 1×2 cm² to obtain dried hydrogel.

Finally, the hydrogel is soaked in 6M LiCl for one day to obtain the hydrogel electrolyte of the experimental example 1.

### Experimental Example 2

The hydrogel is prepared in the same manner as the experimental example 1, but the electrolyte for subsequent soaking is changed to 1M Zn(CF₃SO₃)₂ to obtain the hydrogel electrolyte of the experimental example 2.

### [FTIR Analysis]

FTIR analysis is performed on the dried hydrogel in the experimental example 1 to obtain FIG. 2.

It may be seen from FIG. 2 that the hydrogel of the experimental example 1 has obvious hydrogen bonding blocks, indicating that the hydrogel has tensile properties.

### [Raman Spectroscopic Analysis]

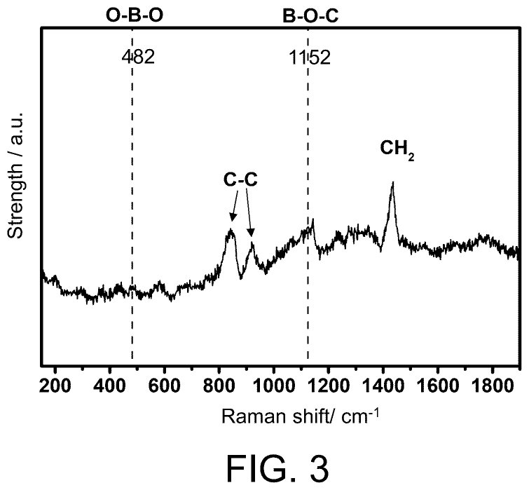

Raman spectroscopic analysis is performed on the dried hydrogel electrolyte in the experimental example 1 to obtain FIG. 3.

It may be seen from FIG. 3 that the hydrogel of the experimental example 1 has self-healable C—C bonds, so that the hydrogel has self-healable properties.

### [Electrochemical Impedance Analysis]

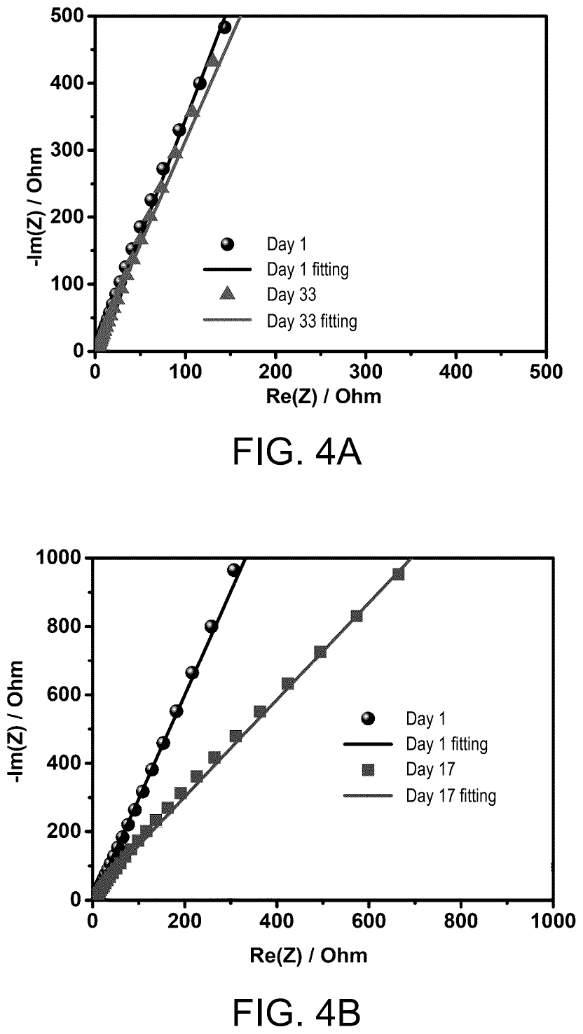

The electrochemical impedance analysis (frequency range: 1M Hz-1 Hz) is respectively performed on the hydrogel electrolyte of the experimental example 1 and the hydrogel electrolyte of the experimental example 2, and results are shown in following Table 1, FIG. 4A and FIG. 4B.

TABLE 1

| | | |
|---|---|---|
| Days | Rₜₒₜₐₗ (Ω) | Ionic conductivity (S cm⁻¹) |

Experimental example 1

| | | |
|---|---|---|
| Day 1 | 1.46 | 1.04 × 10⁻¹ |
| Day 33 | 2.08 | 7.3 × 10⁻² |

Experimental example 2

| | | |
|---|---|---|
| Day 1 | 3.41 | 1.1 × 10⁻² |
| Day 17 | 5.45 | 7 × 10⁻³ |

It may be seen from FIG. 4A and FIG. 4B that the hydrogel electrolytes of the experimental example 1 and the experimental example 2 have good ionic conductivity.

### [Self-Healable Ability Test]

The hydrogel electrolyte of the experimental example 1 and the hydrogel electrolyte of the experimental example 2 are respectively stretched by 100%, i.e., the hydrogel electrolyte with an original length of 2 cm was stretched to 4 cm by hand.

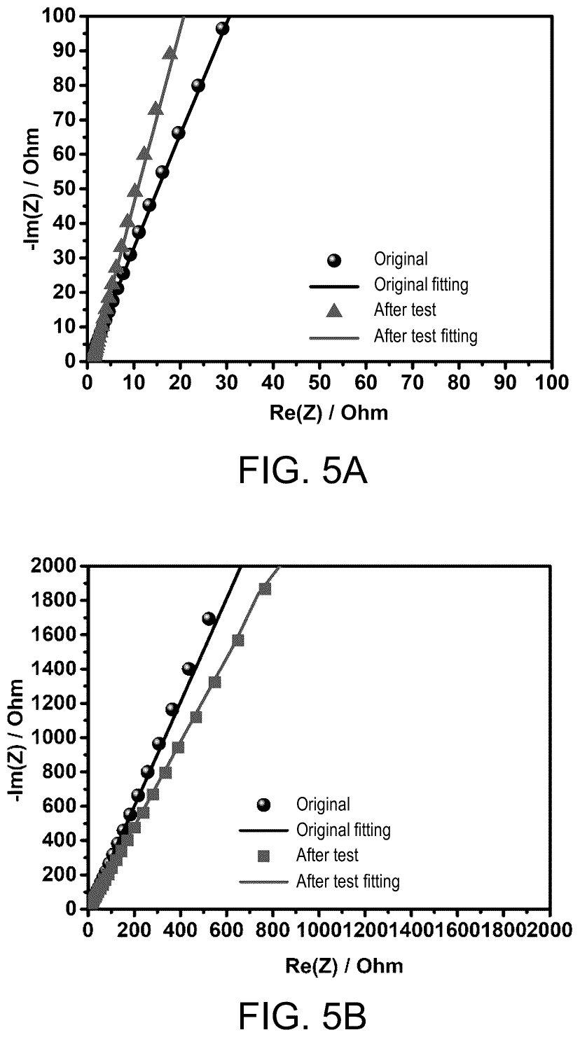

Then, the electrochemical impedance analysis (frequency range: 1M Hz-1 Hz) is performed on the uncut hydrogel electrolyte, and then the hydrogel electrolyte is cut and re-stacked for one day, and then the same electrochemical impedance analysis is performed. The results are shown in following Table 2, FIG. 5A and FIG. 5B.

TABLE 2

| | |
|---|---|
| Rₜₒₜₐₗ (Ω) | Ionic conductivity (mS cm⁻¹) |

| | | | |
|---|---|---|---|
| Before healing | After healing | Before healing | After healing |

Experimental example 1

| | | | |
|---|---|---|---|
| 1.46 | 2.08 | 104 | 100.7 |

Experimental example 2

| | | | |
|---|---|---|---|
| 3.41 | 4.36 | 11.1 | 9 |

It may be seen from Table 2 that healability of the hydrogel electrolyte of the experimental example 1 is 96%, and the healability of the hydrogel electrolyte of the experimental example 2 is 78.12%. Therefore, the hydrogel electrolytes of the experimental example 1 and the experimental example 2 all have good self-healable properties.

### [Experimental Example 3] Fabrication of Supercapacitor

First, 0.8 g of the PVA powder and 0.08 g of the PEO powder are added to 20 mL of water, the mixture is placed on a heating plate and stirred at room temperature for 10 minutes, and then the heating plate is adjusted to 90° C. and the mixture is kept being stirred for about an hour until the powders are completely dissolved. Then, 0.4 mL of 50 mM borax solution is added and stirred for another 10 minutes.

Then, the above solution is poured on a silicon wafer coated with 800 mg MWCNT-COOH, and an active material content of 10 mg cm⁻² is obtained by measurement and conversion. Then, the entire silicon wafer may be subjected to the Freeze-Thawing method, and then the solidified structure is peeled off from the silicon wafer and cut into a 1×2 cm² hydrogel attached single electrode.

The above single electrode is pre-stretched by 100%, and then 10 mg MWCNT-COOH is drop-coated, and placed in a −60° C. freeze dryer to dry for one day.

Then, the above single electrode is soaked in 6M LiCl for one day to obtain the structure of the single electrode/hydrogel electrolyte in the experimental example 3.

Two or more above dried structures are pressed face-to-face to obtain the supercapacitor of the experimental example 3.

### [Electrochemical Analysis]

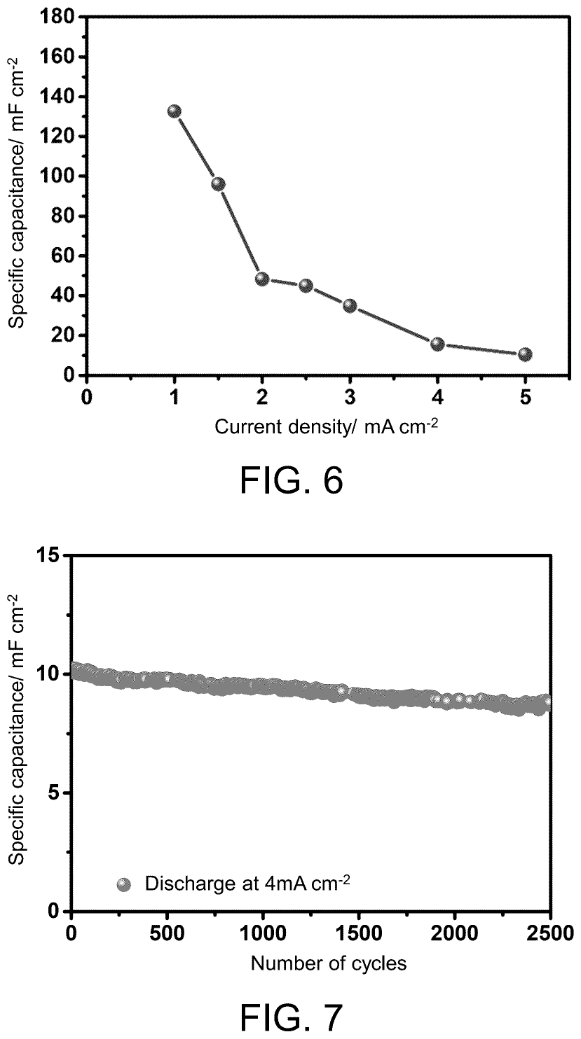

GCD analysis (potential window: 0-1.4 V) and cycle life test are performed on the supercapacitor of the experimental example 3 to respectively obtain curve charts of FIG. 6 and FIG. 7.

It may be seen from FIG. 6 that a specific capacitance of the supercapacitor of the experimental example 3 reaches 142.85 mF cm⁻².

It may be seen from FIG. 7 that the supercapacitor of the experimental example 3 still has a capacitance retention rate of 85.3% after 2500 cycles.

### [Tensile Test]

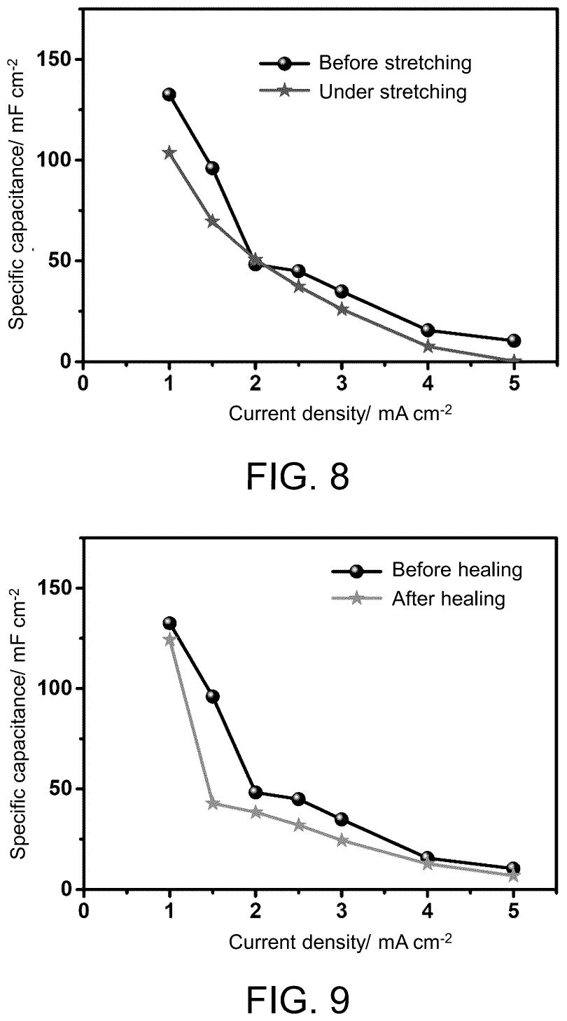

The supercapacitor of the experimental example 3 is stretched by 100%, i.e., the supercapacitor with an original length of 2 cm is stretched to 4 cm by hand, and then GCD analysis is performed to obtain FIG. 8.

FIG. 8 shows GCD curves of the experimental example 3 before stretching and under 100% stretching. It may be seen from FIG. 8 that when the stretching amount is 100%, the capacitance may increase from 125.8 mF cm⁻² specific capacitance value to 102.6 mF cm⁻² specific capacitance value before and after stretching at a current density of 1 mA cm⁻², which is approximately 81.5% of the original value.

### [Self-Healable Ability Test]

Similarly, after the supercapacitor of the experimental example 3 is cut off and re-stacked, the GCD curve thereof is measured after one day of self-healing to obtain FIG. 9.

FIG. 9 shows the GCD curves of the experimental example 3 before and after healing, and it may be seen from FIG. 9 that under the current density of 1 mA cm⁻², the specific capacitance value before and after healing is from 132.6 mF cm⁻² specific capacitance value to 124.3 mF cm⁻² specific capacitance value, which is approximately 87% of the original value. Therefore, even if the supercapacitor of the experimental example 3 is deformed, it may still self-heal and maintain 87% of its performance.

### [Experimental Example 4] Fabrication of Zinc Ion Battery (ZIB)

### 1. Preparation of Positive Electrode Materials

After thoroughly mixing 7.06 mg of SWCNT and 11.25 ml of DI water in advance, 63.382 mg of manganese sulfate hydrate is added and stirred at room temperature for 15 minutes. At the same time, after thoroughly mixing 136.39 mg of V₂O₅ and 18.75 ml of DI water, 0.75 ml of H₂O₂ is added and stirred at room temperature for 30 minutes.

Then, the above two components are mixed and stirred together for 20 minutes, and after a hydrothermal reaction is performed at 120° C. for 6 hours, the positive electrode material MnVOH@SWCNT-5 wt % of the experimental example 4 is obtained after centrifugal separation and freeze-drying for two days.

### 2. Preparation of Positive Electrode

40 mg of MWCNT-COOH and 40 mL of absolute ethanol are mixed and dropped onto a silicon wafer. After heating and drying, a mixed solution containing 160 mg of MnVOH@SWCNT and 20 mL of absolute ethanol is dropped onto its surface. After heating and drying, the positive electrode of the experimental example 4 may be obtained.

### 3. Preparation of Negative Electrode

160 mg of MWCNT-COOH, 320 mg of zinc powder and 45 mL of DI water are thoroughly mixed, and then dropped onto the silicon wafer, and after heating and drying, returned to room temperature.

### 4. Fabrication of Battery

First, 0.8 g of the PVA powder and 0.08 g of the PEO powder are added to 20 mL of water, and the mixture is placed on a heating plate and stirred at room temperature for 10 minutes, then the heating plate is adjusted to 90° C. and the mixture is kept being stirred for about an hour until the powders are completely dissolved. Then, 0.4 mL of 50 mM borax solution is added and stirred for another 10 minutes.

Then, the above solution is poured on the surfaces of the prepared positive electrode and negative electrode respectively, and then the Freeze-Thawing method is carried on, and then the solidified structure is peeled off from the silicon wafer and cut into the positive and negative electrodes with a size of 1×2 cm². The aforementioned positive electrode and negative electrode are pre-stretched by 100%, and then 10 mg MWCNT-COOH is drop-coated, and placed in a −60° C. freeze dryer to dry for one day to obtain dried positive and negative electrodes.

Then, both of the positive electrode and the negative electrode are soaked in 1M Zn(CF₃SO₃) for one day, and then the dried positive electrode and the negative electrode are pressed face-to-face to obtain the zinc ion battery of the experimental example 4.

### [Electrochemical Analysis]

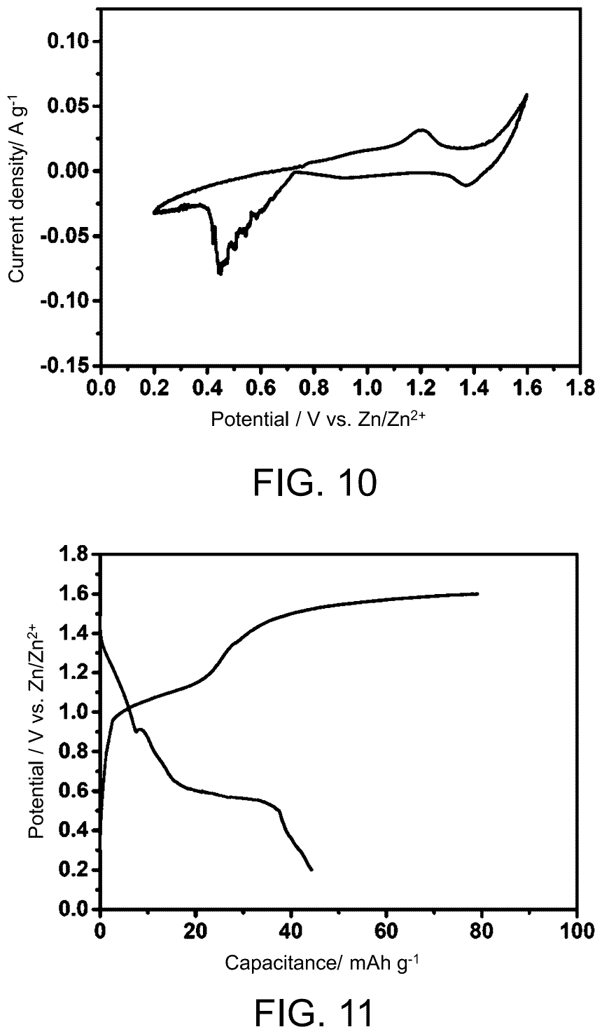

CV analysis is performed on the zinc ion battery of the experimental example 4 (scanning speed: 0.1 mV s⁻¹) to obtain a curve chart of FIG. 10. It may be seen from FIG. 10 that the hydrogel electrolyte of the disclosure may be used in zinc ion batteries.

In addition, GCD analysis (current density: 0.05 A g⁻¹) is performed on the zinc ion battery of the experimental example 4 to obtain a curve chart of FIG. 11. It may be seen from FIG. 11 that the capacity of the zinc ion battery of the experimental example 4 is approximately 47 mAh g⁻¹.

In summary, the disclosure uses the hydrogel prepared by adding the PVA and the PEO with the borax aqueous solution as a material of the electrolyte to prepare the hydrogel electrolyte with both ionic conductivity and mechanical properties, which may be widely used in various electrochemical energy storage devices, such as supercapacitors or aqueous metal ion batteries.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A hydrogel electrolyte, comprising:
a hydrogel, being a product from a reaction of a mixture of polyvinyl alcohol (PVA) and polyethylene oxide (PEO) with a borax aqueous solution; and
electrolyzed salts, distributed within the hydrogel and dissociated into a cation and an anion.

2. The hydrogel electrolyte according to claim 1, wherein a weight ratio of the polyvinyl alcohol to the polyethylene oxide in the mixture is 5:1 to 15:1.

3. The hydrogel electrolyte according to claim 1, wherein taking a total volume of the mixture as 100 vol %, a content of the borax aqueous solution is 0.5 vol. % to 5 vol. %.

4. The hydrogel electrolyte according to claim 1, wherein a volume molar concentration of the borax aqueous solution is between 20 mM and 100 mM.

5. The hydrogel electrolyte according to claim 1, wherein taking a total weight of the hydrogel as a reference, a content of the electrolyzed salts is 15 wt % to 30 wt %.

6. The hydrogel electrolyte according to claim 1, the electrolyzed salts are lithium salts, sodium salts, or zinc salts.

7. An electrochemical energy storage device, comprising the hydrogel electrolyte according to claim 1.

8. The electrochemical energy storage device according to claim 7, wherein the electrochemical energy storage device is a supercapacitor.

9. The electrochemical energy storage device according to claim 7, wherein the electrochemical energy storage device is an aqueous metal ion battery.
